(19) United States
(12) Patent Application Publication
(10) Pub. No.: US 2016/0085831 A1
(43) Pub. Date: Mar. 24, 2016

(54) METHOD AND APPARATUS FOR MAP CLASSIFICATION AND RESTRUCTURING

(71) Applicant: QUALCOMM Incorporated, San Diego, CA (US)

(72) Inventors: Hui Chao, San Jose, CA (US); Chandrakant Mehta, Santa Clara, CA (US); Saumitra Mohan Das, Santa Clara, CA (US); Aravindkumar Ilangovan, Santa Clara, CA (US); Abhinav Sharma, Santa Clara, CA (US)

(21) Appl. No.: 14/493,118

(22) Filed: Sep. 22, 2014

(51) Int. Cl. G06F 17/30; G06F 3/0484

(52) U.S. Cl. CPC G06F 17/30554; G06F 17/30061; G06F 17/30271; G06F 3/04842; G06F 17/30345

(57) ABSTRACT

Method, device, computer program product, and apparatus for performing map classification is described. An unstructured map can be received to determine groups of components within the unstructured map having a same property. Shared properties within the unstructured map can include color, intensity, contrast, and line connectivity. A structured map can be generated by assigning each group of components detected within the unstructured map to a layer. A visual representation of the groups may be presented or displayed within a graphical user interface (GUI), such that each group is a selectable object for manipulation within the GUI. The GUI can receive selections or requests to update one or more properties of the group.

### FIELD

The subject matter disclosed herein relates generally to the creating and editing of maps, and more specifically to map classification and restructuring.

### BACKGROUND

A map is a diagrammatic representation of features within an area or environment. For example, mapped features may relate to or otherwise identify certain physical objects, characteristics, or points of interest within an indoor environment (e.g., building, venue, or complex, etc.). Maps are referenced in a variety of different applications. For example, some maps are used for assisting a mobile device user with navigation in a variety of environments.

An indoor navigation system may provide a digital electronic map to a mobile device in response to entering a particular indoor area, or in response to a request for position assistance data. Such a map may show indoor features (e.g., doors, hallways, entry ways, walls, etc.), and points of interest (e.g., bathrooms, pay phones, room names, stores, bank machines, information desks, etc.) Indoor navigation maps may also contain information related to positioning via radio signal measurements within a mapped environment. For example, various radio signal characteristics may be gathered for an area and leveraged to create various signaling environment characteristic models (such as radio heatmaps). The heatmaps may be maintained and refined over time, and which may allow for location position determination by mobile devices within an indoor structure.

Indoor navigation maps may be created and maintained by a venue's network administrator and provided to mobile devices. However, the process for creating and maintaining indoor navigation maps may be tedious and time consuming for venue's network administrators because the maps may lack useful/relevant structure, or details for the particular user application (e.g., in an indoor navigation, or other specialized context). For example, the administrator may have access to limited versions of maps created by a building architect or used by building maintenance (e.g., blueprints). However, the original version of the administrator's map is often not accessible or provided. Therefore, some original details recorded in a map by a building architect or original map creator may not be readily accessible or provided to network administrators who may maintain a building's network long after a building has been designed. For example, original details in the maps are lost in the conversion of a map from vector format to raster image format, or when a digital file is printed to paper and later scanned back into another digital format.

Furthermore, original maps (e.g., digital versions in usable file format), even when available, may not be relevant to the particular use of the network administrator or other end user. To change a map of generic format into a framework supporting specialized formats can be tedious manual process as time consuming as starting to create a map from scratch. For example, each line within a map may need to be manually created, or assigned with useful properties relevant to the particular end user's desired output. Therefore, improved mapping techniques are can help improve the adoption and accuracy of indoor positioning for indoor venues.

### SUMMARY

Embodiments disclosed herein may relate to a method for classifying a map. The method includes receiving an unstructured map of an environment and detecting a first group of components within the unstructured map sharing a first property. The method further includes detecting a second group of components within the unstructured map sharing a second property. The method further includes generating a structured map by assigning the first group of components detected within the unstructured map to a first layer and assigning the second group of components detected within the unstructured map to a second layer.

Embodiments disclosed herein may relate to a machine readable non-transitory storage medium with instructions to perform map classification. The medium includes instructions for receiving an unstructured map of an environment and detecting a first group of components within the unstructured map sharing a first property. The medium further includes instructions for receiving detecting a second group of components within the unstructured map sharing a second property. The medium also includes instructions for receiving generating a structured map by assigning the first group of components detected within the unstructured map to a first layer and assigning the second group of components detected within the unstructured map to a second layer.

Embodiments disclosed herein may also relate to an apparatus to classify a map. The apparatus includes means for receiving an unstructured map of an environment and detecting a first group of components within the unstructured map sharing a first property. The apparatus further includes means for detecting a second group of components within the unstructured map sharing a second property. The apparatus further includes means for generating a structured map by assigning the first group of components detected within the unstructured map to a first layer and assigning the second group of components detected within the unstructured map to a second layer.

Embodiments disclosed herein may further relate to a data processing device including a processor and a storage device configurable for storing instructions to classify a map. The device includes instructions for receiving an unstructured map of an environment and detecting a first group of components within the unstructured map sharing a first property. The device further includes instructions for detecting a second group of components within the unstructured map sharing a second property. The device further includes instructions for generating a structured map by assigning the first group of components detected within the unstructured map to a first layer and assigning the second group of components detected within the unstructured map to a second layer.

Other features and advantages will be apparent from the accompanying drawings and from the detailed description.

### BRIEF DESCRIPTION OF THE DRAWINGS

FIG. 1 is block diagram illustrating an exemplary device in which embodiments of the invention may be practiced;

FIG. 2 illustrates a method for performing Map Classification and Reconstruction (MCR), in one embodiment;

FIG. 3 illustrates a method for performing MCR, in another embodiment;

FIG. 4 is a block diagram illustrating a mixed selector, in one embodiment;

FIG. 5 illustrates a map of a uniform environment type, in one embodiment;

FIG. 6A illustrates an input map of a mixed environment type, in one embodiment;

FIG. 6B illustrates a graphical user interface selection of an exterior layer in the map of FIG. 6A, in one embodiment;

FIG. 6C illustrates a graphical user interface selection of a connected to exterior layer in the map of FIG. 6A, in one embodiment;

FIG. 6D illustrates a graphical user interface selection of an unconnected to exterior layer in the map of FIG. 6A, in one embodiment;

FIG. 6E illustrates graphical user interface selection of an unconnected to exterior layer in the map of FIG. 6A, in another embodiment;

FIG. 7A illustrates an input map of a mixed environment type, in another embodiment;

FIG. 7B illustrates a contrast selection result based upon processing of the map of FIG. 7A, in one embodiment;

FIG. 7C illustrates an intensity selection result based upon processing of the map of FIG. 7A, in one embodiment;

FIG. 7D illustrates an intensity selection result based upon processing of the map of FIG. 7A, in another embodiment;

FIG. 7E illustrates the map of FIG. 7A with the annotation component layer(s) removed, in one embodiment; and

FIG. 7F illustrates a contrast selection result based upon processing of the map of FIG. 7E, in one embodiment.

### DESCRIPTION

Aspects of the invention are disclosed in the following description and related drawings directed to specific embodiments of the invention. Alternate embodiments may be devised without departing from the scope of the invention. Additionally, well-known elements of the invention may not be described in detail or may be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device (e.g., a server or device). It will be recognized that various actions described herein can be performed by specific circuits (e.g., application specific integrated circuits), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

In one embodiment, a Map Classification and Reconstruction (MCR) module or engine receives an input map and creates a structured map. The structured map can be, in some implementations, a vector map. The input map may be an unstructured map, for example a flat map without layers, having a single layer, or a map with ungrouped/unorganized components. In some embodiments, the unstructured input map is an image (e.g., raster) map created from a digital scan of a physical (e.g., paper) map such that any context data embedded within an original digital version is lost or unavailable in the unstructured input map. In some embodiments, the input map is a map with a component structure having an incompatible or incomplete format/organization for use with a user selected or default application. For example, the input map may have components organized according to properties or attributes (e.g., electrical wiring, air circulation, plumbing system) unrelated to use for indoor navigation (e.g., heatmap, routability map, or other applications). In one embodiment, MCR receives an input map assumed to be unstructured, or having unknown, arbitrary, or irrelevant (to end use output) structure, and creates a structured map that can be leveraged with one or more specified output formats. In one embodiment, the structured map includes at least one layer (i.e., group), and each layer includes one or more components having a similar or shared property determined by MCR (e.g., according to appearance or connected component analysis). The structured map may also contain metadata assigned by a user for each layer, or users may create custom layers according to metadata. Metadata may be assigned to layers or individual components within a layer (layer components). Metadata may include material type of walls, radio propagation values, descriptions, tags, or other characteristics of layers or individual components. In one embodiment, MCR processes the structured map and metadata to create a routability map, heatmap, or other specialized output.

In one embodiment, MCR receives changes or additions to the structured map through a graphical user interface (for example GUI 170). Through GUI 170, users may select one or more layers or layer components and add, remove, or edit, metadata (e.g., context, attributes, semantic data, etc.) associated with the selected layers or layer components. For example, MCR may create a structured map with one or more layers, a first layer having a shared property of connected exterior lines/walls within the map. In one embodiment, the aforementioned first layer of exterior lines/walls may be assigned metadata such as physical material type, text label, radio frequency (RF) propagation value, routability classification, or any other attribute that may be user determined or configured. In one embodiment, MCR can leverage the structured map and associated metadata to create RF heatmaps, and/or routability maps.

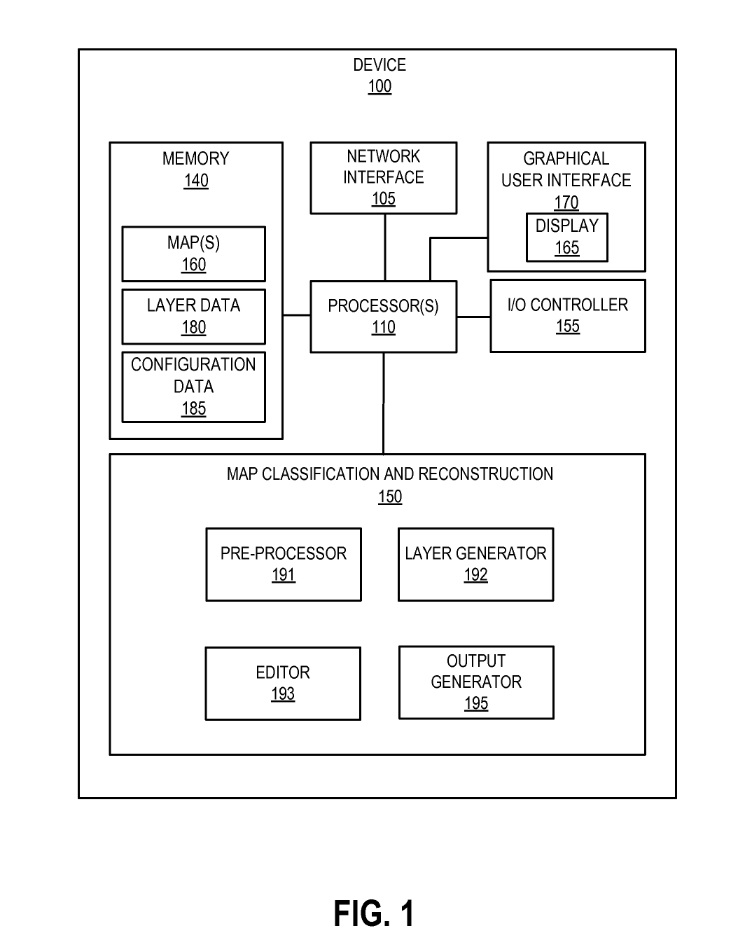

FIG. 1 is block diagram illustrating an exemplary device in which embodiments of the invention may be practiced. For the sake of simplicity, the various features and functions illustrated in the box diagram of FIG. 1 are connected together using a common bus meant to represent that these various features and functions are operatively coupled together. Those skilled in the art will recognize that other connections, mechanisms, features, functions, or the like, may be provided and adapted as necessary to operatively couple and configure a data processing system (for example, device 100). Further, it is also recognized that one or more of the features or functions illustrated may be further subdivided or combined.

The device 100 may include a network interface 105 configured to communicate with a network (not shown), which may be configured to communicate with other devices, computers, and devices. A processor 110 may be connected to the network interface 105, and the memory 140. The processor may include one or more microprocessors, microcontrollers, and/or digital signal processors that provide processing functions, as well as other calculation and control functionality. The memory 140 can store data and software instructions for executing programmed functionality within the device. The memory 140 may be on-board the processor 110 (e.g., within the same integrated circuit (IC) package), and/or the memory may be external memory to the processor and functionally coupled over a data bus.

In one embodiment, device 100 includes a graphical user interface (GUI) 170 that includes a means for presenting (for example, displaying) an image on display 165. In one embodiment, GUI 170 presents a visual representation of the structured and unstructured maps to the user for interaction via GUI 170 input components. GUI 170 input components can provide a direct manipulation user interface for aspects of MCR as described herein. The user input components for GUI 170 may include a keyboard, keypad, touch panel, multi-touch panel, mouse or other input device through which the user can input data or commands into device 100. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to device 100. If desired, integrating a virtual keypad into display 165 with a touch screen/sensor may obviate the keyboard or keypad.

In one embodiment, the visual representation of GUI 170 may include graphical elements (for example, user-selectable graphical elements) such as windows, controls, tabs, menus, icons, interaction elements, etc. Interaction elements may include cursors, pointers, insertion points, selection highlights, etc. GUI 170 may provide a two or three dimensional representation of maps, layers, groups, components, etc.

Device 100 may include other elements unrelated to the present disclosure, such as a satellite position system receiver, power device (for example, a battery), as well as other components typically associated with portable and non-portable electronic devices. Device 100 can be a portable electronic device (e.g., smart phone, laptop computer, data assistant, tablet, etc.).

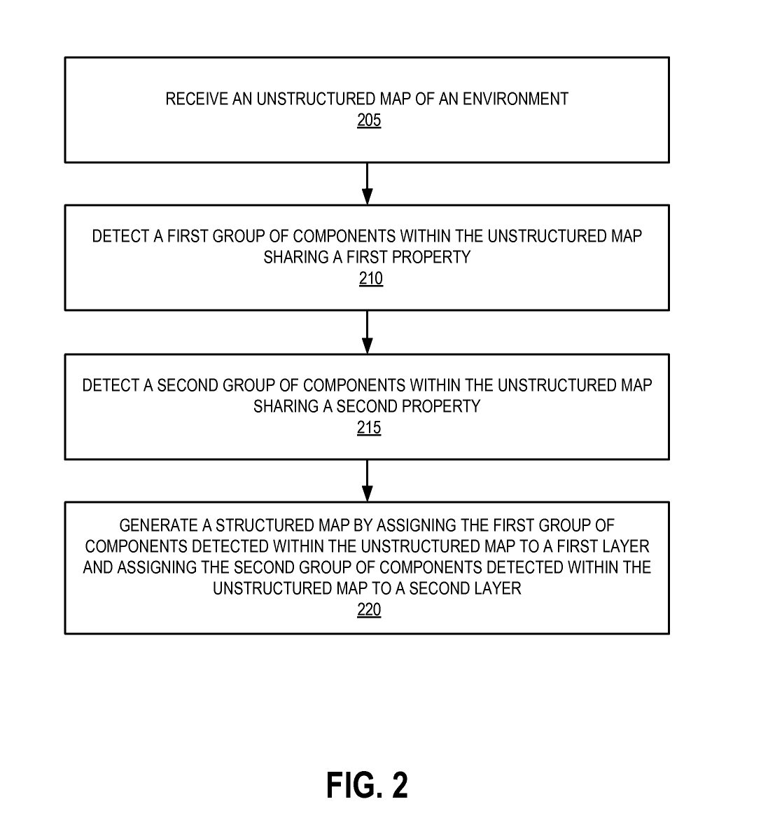

Memory 140 may be coupled to processor 110 to store instructions (for example, instructions to perform methods associated with MCR, and FIGS. 2, 3, and 4) for execution by processor 110. In some embodiments, memory 140 is non-transitory. Thus, the memory 140 is a processor-readable memory and/or a computer-readable memory that stores software code (programming code, instructions, etc.) configured to cause the processor 110 to perform the functions described. Alternatively, one or more functions associated with FIGS. 2, 3, and 4 may be performed in whole or in part in device hardware.

A number of software modules or data tables may reside in memory 140 and be utilized by the processor 110 in order to manage communications, and MCR functionality. As illustrated in FIG. 1, memory 140 may include map(s) 160, layer data 180, and configuration data 185. One should appreciate that the organization of the memory contents as shown in FIG. 1 is merely exemplary, and as such the functionality of the modules and/or data structures may be combined, separated, and/or be structured in different ways depending upon the implementation of the mobile device.

MCR 150 may be a process running on the processor 110 of device 100 or may be a hardware component of device 100. MCR 150 may include one or more sub-modules or components, such as pre-processor 191, layer generator 192, editor 193, and output generator 195. In one embodiment, pre-processor 191 implements functionality relating to receiving an input map and formatting the map for layer generation and editing with MCR 150. For example, pre-processor 191 may receive an input raster image map and create a type of vector map. pre-processor 191 may read configuration parameters from configuration data 185, such as thresholds for determining how pixels in a raster image should be interpreted as contiguous lines and when to assign line breaks or separators. In one embodiment, layer generator 192 implements functionality relating to assigning map components to their respective layer(s). In one embodiment, editor 193 implements functionality relating to processing requests (for example, requests received by GUI 170) for modifying the layers, layer components, and metadata. In one embodiment, editor 193 enables efficient selection of a group of points (for example, map sections or lines) within a map, and adding, removing, or editing metadata (e.g., structure material, attributes, descriptions, other characteristics, etc.). In one embodiment, output generator 195 reads Layer Data 180 to create structured maps, heatmaps, and/or routability maps (for example, Map(s) 160). Further details of MCR 150 and various embodiments of MCR 150 sub-modules are described below with reference to FIGS. 2, 3, and 4.

Processor 110 may include any form of logic suitable for performing at least the techniques provided herein. For example, processor 110 may be operatively configurable based on instructions in memory 140 to selectively initiate one or more routines that exploit motion data for use in other portions of the mobile device. Device may 100 may also include an input/output controller 155 to provide any additional suitable interface systems, such as a microphone/speaker, or peripheral device that allows for data to be received by the device.

In some embodiments, other resources (devices or servers) may represent one or more computing platforms from which device 100 may obtain certain data files and/or instructions, and/or to which device 100 may provide certain data files and/or instructions. In certain instances, all or part of an electronic map, a heatmap, a connectivity map, a routability map, and/or the like may be received by device 100 from one or more other resources (devices or servers), or may be sent to the other resources. For example, device 100 may receive an input unstructured map, where the unstructured map includes at least one of a vector or a raster component, or both. In one embodiment, in response to processing the input map to determine layers and semantic information, MCR creates a file (e.g., XML, flat file, database, other data storage format, etc.) or files readable by a separate device or server. The created file may include sufficient data to be loaded into a RF propagation engine or module and create an RF heatmap. For example, MCR can provide output data to a RF propagation tool, such as that offered by AWE Communications GmbH, which can then provide the RF heatmap or other assistance data for use in indoor positioning systems.

FIG. 2 illustrates a method for performing MCR in one embodiment. At block 205, the embodiment (for example, MCR) receives an unstructured map of an environment. For example, MCR (for example, pre-processor 191) may receive an input map representing a topographical layout of an environment (e.g., venue, location, building, floor, structure, etc.). An unstructured map may be a representation, without assigned groups or layers, of the environment's topographical layout. The input map may be a vector map, raster image map, or a combination. The input map may include features or elements such as doors, hallways, entry ways, walls, etc., or points of interest such as bathrooms, pay phones, room names, stores, etc. The features or elements may be represented within the map as a number of lines (vectors, or connected pixels) with varying width as viewed from the top of the environment. The map may designate walls of different thickness by representing lines of having a similar relative thickness. Openings on the walls (e.g., doors, windows, etc.) may be indicated by special signatures such as a pair of thin lines.

As used herein, raster images (for example, raster image maps), figures, or drawings are collections of individually colored points (or “pixels”) that, when viewed as a whole, form a picture representation of the environment. A raster image map references the pixels in a defined grid rather than vectors. For example, a raster image map may be a bitmap or dot matrix data structure representing a grid of points of color/pixels. Examples of raster formats compatible with embodiments described herein include, but are not limited to, Graphical Interchange Format (GIF), Windows Bitmaps (BMP), Tagged Image File Format (TIFF), Joint Photographic Experts Group (JPEG), Truevision Graphics Adapter (TGA), Apple PICT, and Postscript.

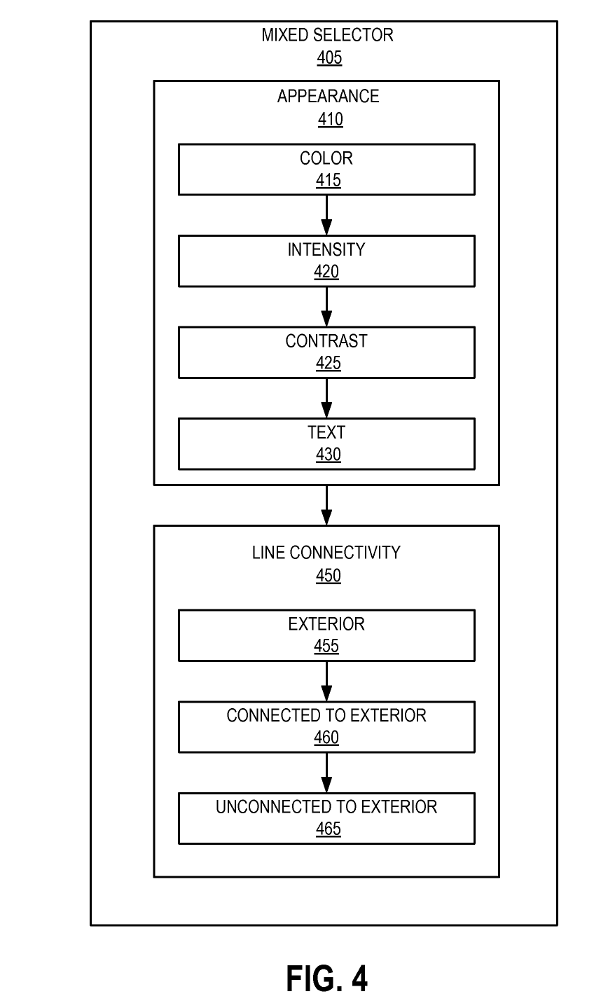

At block 210, the embodiment (for example, layer generator 192), detects a first group of components within the unstructured map sharing a first property. Properties can include one or more of color, intensity, relative contrast, or line connectivity, or any combination thereof. For example, a property may be shared if two or more components have a same color within a threshold variation, a same intensity within a threshold variation, a same relative contrast within a threshold variation, are exterior walls, or share line connectivity, or any combination thereof. In some embodiments, two or more different types of shared properties may be grouped together as one group or assigned to separate groups. Further details of property analysis and grouping are described below with regards to FIG. 4.

At block 215, the embodiment (for example, layer generator 192), detects a second group of components within the unstructured map sharing a second property. The second group of components may be a different property than the property of the first group of components. For example, layer generator 192 can group components sharing a “yellow” color property together as a first group, and can group components sharing an “exterior wall” property together as a second group. Alternatively, layer generator 192 may be configured to create a group with yellow and exterior wall properties into a single group. Many other combinations and properties are possible.

At block 220, the embodiment (for example, layer generator 192), generates a structured map by assigning the first group of components detected within the unstructured map to a first layer and assigning the second group of components detected within the unstructured map to a second layer. In one embodiment, MCR receives at least one of: a first physical material type assignment (for example, metadata) for the first group of components, or a second physical material type assignment for the second group of components.

In one embodiment, MCR can generate a RF propagation heatmap according to the structured map having one or more components or groups with assigned material types. For example, MCR can generate a RF propagation heatmap according to the structured map comprising the first group of components having the first physical material type and the second group of components having the second physical material type.

In some embodiments, MCR generates a routability map according to the structured map. In one embodiment, MCR (for example, output generator 195) converts raster images or drawings into vector drawings, or other vector data based representations. Vector drawings may be a collection of individual lines or polygons, based on mathematical expressions, to represent an image (map). Examples of vector formats include AutoCAD drawing files (DWG), Windows Metafiles (WMF), and Autodesk Drawing Exchange files (DXF).

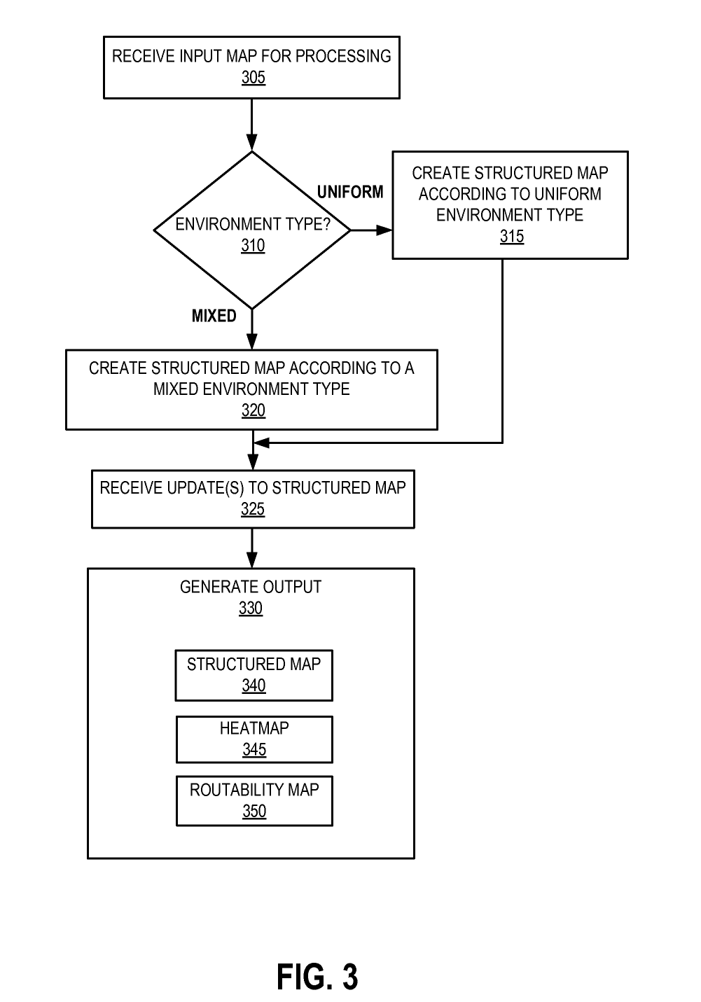

FIG. 3 illustrates a method for performing MCR, in another embodiment. At block 305, the embodiment (for example, pre-processor 191) receives an input map for processing. In one embodiment, the input by MCR is an unstructured map without any previously created or assigned layers. The input may be a raster image, such as a raster image obtained from a digital scan of a physical paper map. In some embodiments, the input map is structured, however the structure is arbitrary or unrelated to a user's end usage application.

At block 310, the embodiment (for example, layer generator 192) determines an environment type for the input map. For example, MCR may receive a user identification or description of an environment type associated with the input map. The environment type may be a uniform environment type, or a mixed environment type. In one embodiment, MCR references the environment type to determine how to process the input map into layers. For example, in response to determining the input map is a uniform environment type, MCR may perform a line connectivity analysis assuming outer (for example, exterior) line segments are assigned to the same layer as inner (for example, interior) line segments. A uniform environment type (for example, walled office building) typically has interior walls connected to exterior walls, where a majority of the interior walls are a similar material and design type. Another layout type may be a layout for environments having mixed property types (for example, material or design of elements or components varies within the environment and may vary from the material or design of the exterior walls). Example mixed environment types includes: warehouses, cubical offices, department stores, museums, and theatres, just to name a few. In some embodiments, instead of, or in addition to a mixed environment type, one or more of warehouses, cubical offices, department stores, museums, and theatres may be a separate environment type. For example, a user or MCR may recognize the environment type as being a warehouse environment having one or more default settings associated with warehouse type environments such as large interior spaces, interior shelving, or other components non-connected to the exterior wall.

At block 315, in response to determining the input map is a uniform environment type, the embodiment (for example, layer generator 192) creates a structured map according to a uniform environment type. Processing the input map as a uniform environment type may include assuming homogeneous or consistent material or design of interior obstructions with the input map. For example, as illustrated in FIG. 2, a walled office environment may be assumed as having a consistent uniform interior layout comprising the same or similar materials and structure for all interior components. Therefore, in response to determining the input map is of a uniform environment type, MCR may group the interior components (e.g., obstructions, features, walls, other mapped elements, etc.) as part of the same layer. In some embodiments, MCR creates a second layer to group the exterior walls of map having a different uniform material type than the interior walls. For example, a uniform environment type may have similar interior components, while also having second/different exterior materials. Therefore, MCR may optionally via a configuration (for example, configuration data 185) or user selection, layer exterior components separately from interior components for a uniform environment type.

At block 320, in response to determining the input map is a mixed environment type, the embodiment (for example, layer generator 192) creates a structured map according to the mixed environment type. In one embodiment, MCR processes a mixed environment type map with a mixed selector module, or engine. For example, mixed selector module 405 may include an appearance module 410 to separate and group map components according to one or more aspects (for example, common or shared properties) such as color, intensity, text and contrast. Mixed selector module 405 may also include line connectivity module 450 to perform line connectivity analysis for lines (for example, adjacent pixels) within the input map.

In one embodiment, line connectivity analysis (for example, implemented by line connectivity module 450) may include determining exterior walls, interior components coupled to exterior wall components, interior components uncoupled from an exterior wall components, a plurality of coupled interior components, components connected to the exterior walls (for example, an exterior wall connected to an other exterior wall component), or components un-connected to the exterior walls of the input unstructured map, or any combination thereof. MCR's mixed selector module 405 is described in detail below with respect to FIG. 4.

At block 325, the embodiment (for example, editor 193) receives updates (for example, changes, or modifications) to one or more aspects of the created structured map. In some embodiments, MCR creates a structured map with each layer (for example, group of components) assigned to a default or selected property or attribute (for example, physical material type). The property or attribute may be machine or user-selected in some embodiments. For example, one or more lines may be classified (for example, by a user through a GUI) as walls having a brick or other physical material type. In some embodiments, metadata may be set to a default null value for lines or components and MCR may request that a user specify actual values or changes in response to assigning the component(s) to a respective layer. Editor 193 may also receive metadata to classify one or more components as blocking or non-blocking with regards to a routability map. Editor 193 may also receive metadata to label components in a layer for ease of organization (for example, a layer may be labeled as “shelves” or “cubicles”). Other metadata changes are possible and may be setup as part of configuration data 185.

In one embodiment, MCR receives updates to the structured map through GUI 170 of device 100 implementing MCR. For example, a representation (for example, visual representation via GUI 170) of the structured map and user selectable objects within the structured map may be displayed on device 100 implementing MCR. GUI 170 may receive inputs from a user through a touch screen interface, mouse, keyboard, or other user interface as known in the art. A user may edit (for example, through the GUI or other interface) the properties or attributes of individual components in a layer of the structured map created at blocks 315 or 320. In one embodiment, to provide a RF signal heatmap, MCR receives metadata related to RF signal propagation. In one embodiment, a layer may be tagged or otherwise associated with a RF loss descriptor such as a physical material type (e.g., brick, wood, metal, glass, other material, etc.) or path loss/attenuation value. The path loss/attenuation as used herein represents the reduction in power density (for example, attenuation) of electromagnetic waves as they propagate through the defined space. For example, path loss/attenuation may be associated directly to layers or layer components (for example, within a structured map).

At block 330, the embodiment (for example, output generator 195) generates one or more types of output. For example, the output may be a structured map (for example, a general use map that may be further processed or used as reference in a third party program or other system separate from MCR), a routability map, heatmap, or other type of assistance data for mobile devices to facilitate and/or enable various location based services. In one embodiment, a user requests a particular type of output (for example, within a GUI or other interface). In one embodiment, MCR outputs (for example, by output generator 195) a structured map containing the layers determined by MCR. The structured map may be used as an input to another separate process or system, such as a third party program or device.

In one embodiment, output generator 195 receives a request to generate heatmap 345. For example, the heatmap may be a radio frequency heatmap (i.e., RF signal probability/prediction map) indicating and/or otherwise modeling expected received signal strength indicator (RSSI) and/or round-trip delay times associated with access points within an environment. The RF heatmap data may enable a mobile device to associate signal measurements with locations in an environment. A RF heatmap may be computed based, at least in part, on one or more features or elements of an environment, such as walls, doors, hallways, rooms, as well as building materials or structure information relating to each of the one or more features in the environment. For example, a glass window may have different RF propagation properties represented within the heatmap than the RF propagation properties of a steel door.

In some embodiments, grid points may be laid over map locations in an environment at uniform or non-uniform spacing and physical material information or RF propagation data may be assigned to the one or more points. In some embodiments, GUI 170 is used to manipulate or reorganize one or more grid points, spacing, and physical material information.

In one embodiment, MCR generates a RF propagation heatmap according to a structured map comprising one or more groups of components each having different physical material types. In one embodiment, a computing device (for example, device 100) calculates the RF heatmap and/or other corresponding probability functions/models for one or more map components.

In one embodiment, output generator 195 receives a request to generate a routability map (for example, routability map 350). As used herein, a routability map identifies one or more navigation constraints within the environment, for example navigation constraints for a pedestrian user with a mobile device. Routability map 350 may include a floor plan of an environment derived from the structured map. Obstructions/components within the floor plan, such as walls, room dividers, cubicles, display shelves, etc., may represent navigation constraints (for example, blocking a pedestrian path). Routability map 350 may, for example, comprise derivative information which may specify feasible routes that a mobile device may be able to follow while navigating within the mapped environment. For example, by defining feasible areas for navigation, MCR may apply constraints to aid in the application of filtering measurements for estimating locations and/or motion trajectories according to a motion model (for example, according to a particle filter and/or Kalman filter).

FIG. 4 is a block diagram illustrating a mixed selector module, in one embodiment. A mixed selector (for example, mixed selector module 405) may be a module integrated into MCR or may be implemented separately and called or referenced by MCR. In one embodiment, in response to determining the input map is classified as a mixed environment type, mixed selector module 405 processes the input map to group components of the input map into layers. As used herein, a layer refers to a group or association of components (e.g., pixels, text, color, contrast, or line segments, other map element, etc.) having a similar or shared property. For example, mixed selector module 405 may determine a color (component) composed of blue elements is a first shared property of an input map that defines a first layer. Additionally, mixed selector module 405 may also determine an intensity (component) composed of “bright” (for example, according to configurable intensity thresholds) elements is a second shared property of an input map that defines a second layer.

In one embodiment, mixed selector module 405 can determine a single layer includes two or more shared properties. For example, mixed selector module 405 may determine “text” as a shared property and also add “high contrast” elements as two different shared properties to define a third layer. Other combinations are possible and configurable. Layers, as used herein does not necessarily imply a specific order or sequence of grouping. For example, a structured map's layers may be arranged without a top, bottom, or other respective location in a stack or level/position specified relative to each other layer.

In one embodiment, mixed selector module 405 includes appearance module 410 and/or line connectivity module 450 (for example, implemented as modules or engines) for grouping or layering components extracted from the input (unstructured) map. Appearance module 410 may include one or more of color 415, intensity 420, contrast 425, and/or text 430 sub-modules. Line connectivity module 450 may include one or more of exterior 455, connected to exterior 460, and unconnected to exterior 465 sub-modules. In some embodiments, appearance module 410 and line connectivity module 450 may be one component rather than separate modules. Each of the sub-modules of mixed selector module 405 may be triggered or processed in any order or sequence as specified by a user or by configuration data 185.

In one embodiment, color 415 associates map components (e.g., pixels, lines, elements, features, etc.) having a same or similar (for example, within a configurable threshold difference) color with a layer. For example, the input map may illustrate a number of shelving units with the color red, and the color 415 can assign these red shelving units to a layer. Although color 415 may not be able to differentiate between shelves and other map components, because the shelves are illustrated in the map with the same or similar color, the user benefits from having a layer containing all the shelves in the map. Like other layers as described herein, the user can add, remove, or edit metadata for layers, and may tag the resulting shelving layer as “shelves.” Additionally, the user may have knowledge of the design and material of the shelves, and add metadata to the shelves layer so that the shelves layer may be included or excluded in a heatmap accordingly. In one embodiment, the color threshold may be user adjustable or set within configuration data 185. For example, one color layer threshold may be set so as to include red, orange, and yellow. In another example, one output from the color sub-module may include a layer with all colors within the input map except black or white, while another separate layer includes just the black and white components of the input map. Many other combinations or settings are possible.

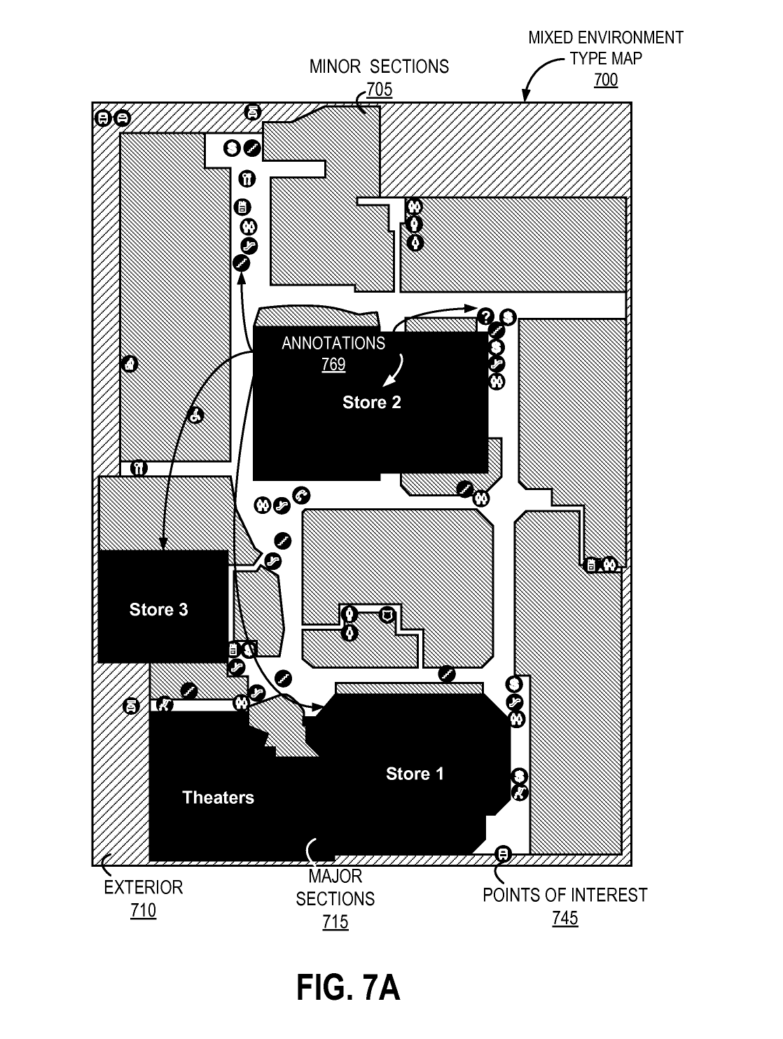

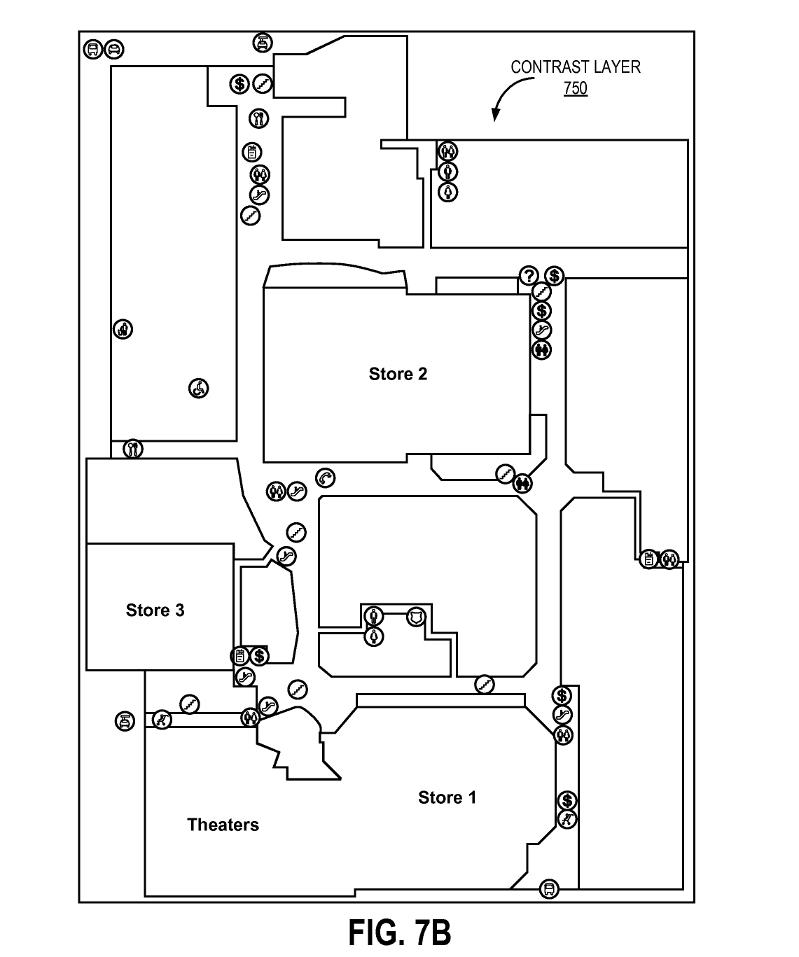

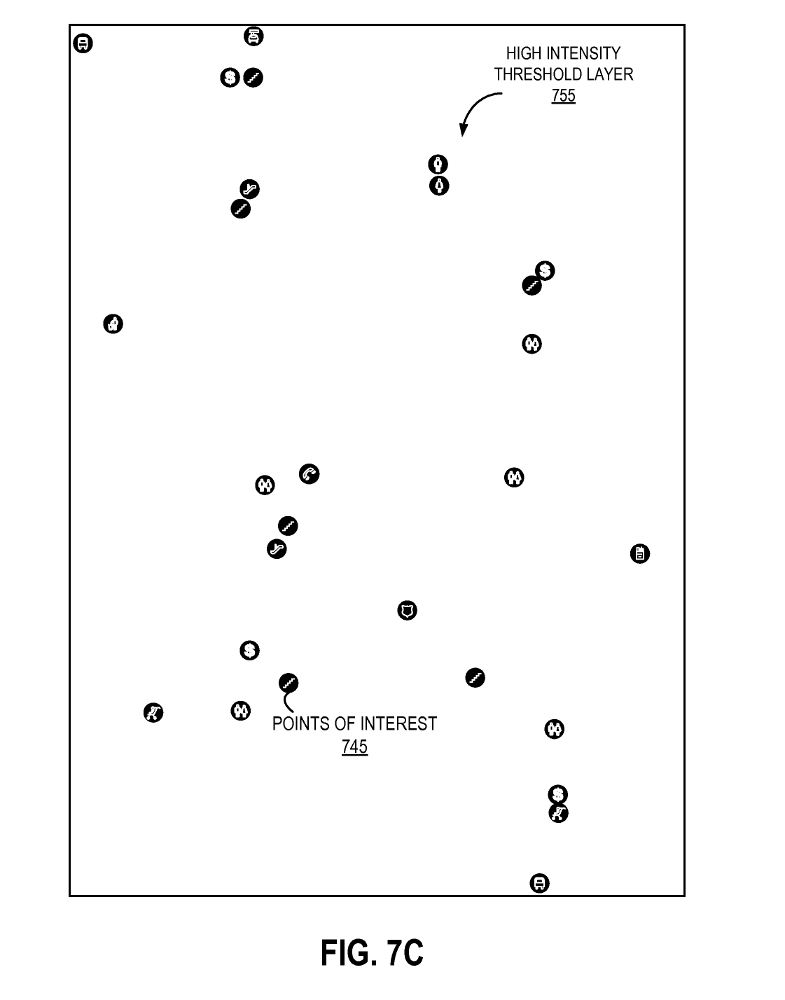

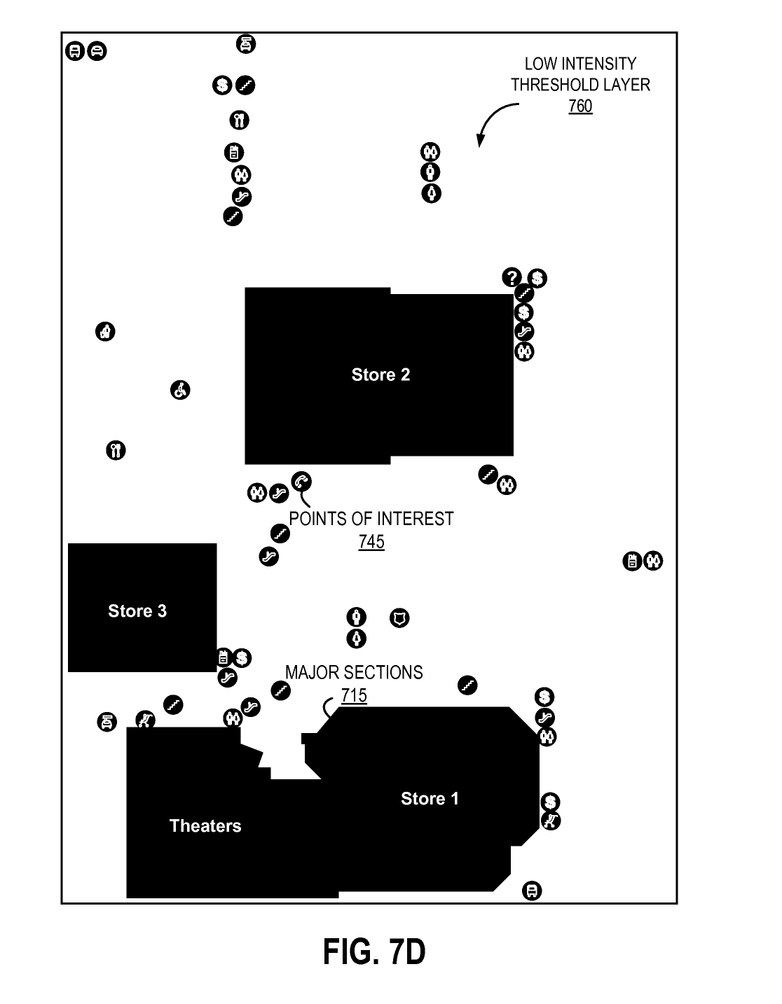

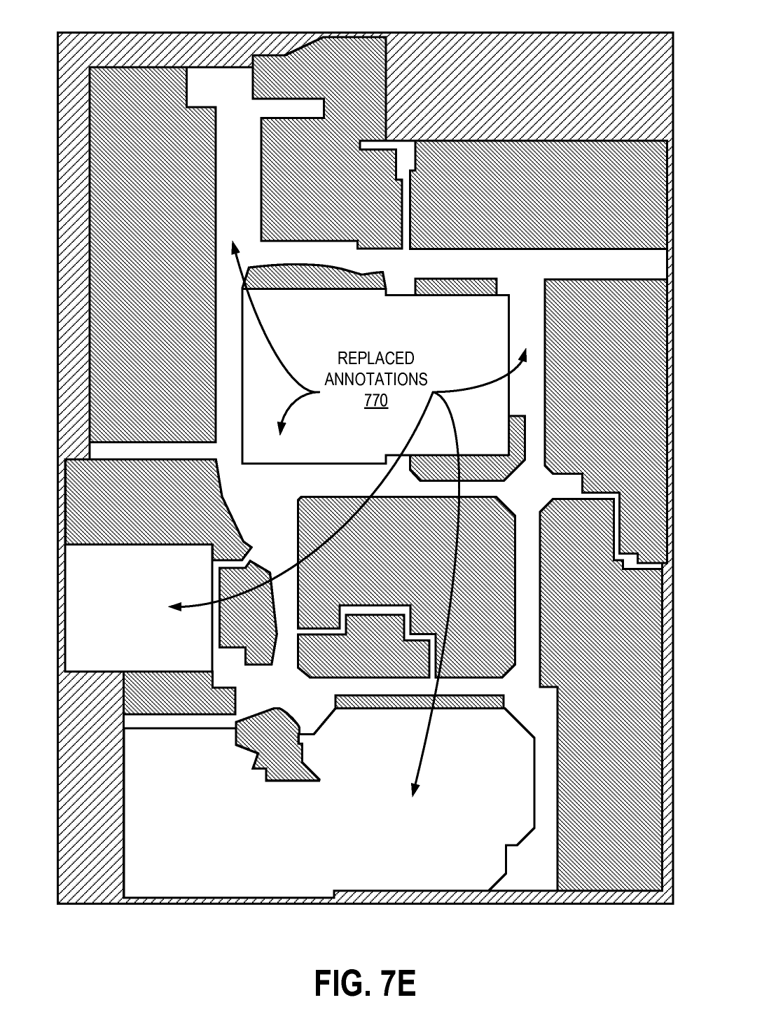

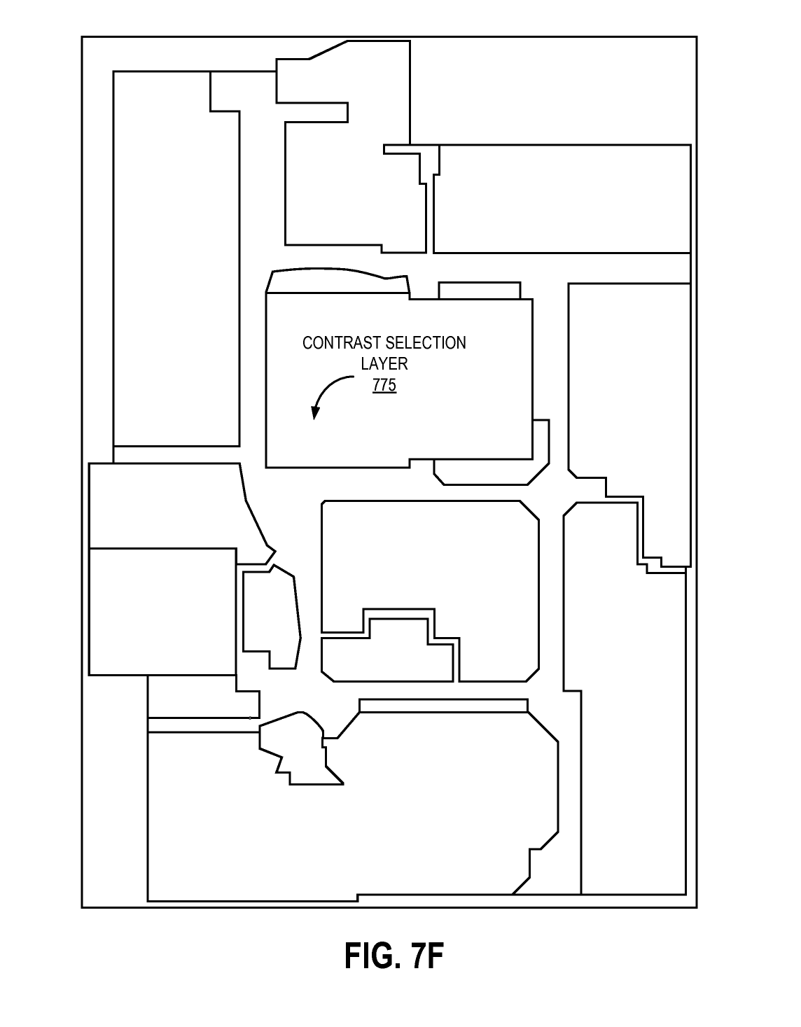

In one embodiment, intensity 420 associates map components with a layer having a same or similar (for example, within a configurable threshold difference) of intensity. Intensity as used herein, describes describe the brightness of a color, and can also be described as chroma, or saturation. Intensity may be measured on a scale from bright to dull. In one embodiment, intensity 420 determines one or more of: color saturation, luminance, or the total intensity of RGB (red, green, and blue) as calculated by the square root of (R²+G²+B²). FIG. 7D illustrates a layer selected by intensity 420, in one embodiment.

In one embodiment, contrast 425 associates map components with a layer having a same or similar (for example, within a configurable threshold difference) contrast. Contrast as used herein, refers to the change of color or intensity and is beneficial for identifying edges within an image. For example, FIG. 7F below is an example contrast selection layer 775 resulting from processing of contrast 425.

In one embodiment, text 430 associates map components with a layer according to text or other descriptors. In some embodiments, when creating a heatmap or routability map according to the structured map, the text layer is automatically ignored, or discarded, or may be removed before processing other (subsequent) sub-modules. In some embodiments, adjacent components to text may be assigned the respective text as metadata. For example, if a color component has a text description associated with it, the color layer may receive the text description as associated metadata. In some embodiments, a map key may be detected by text 430 and also applied to respective layers determined by one or more sub-modules. For example, the map key may show that red lines are described with associated text as “Shelves,” and the “Shelves” text may be associated with the layer that includes the red lines as a component.

In one embodiment, line connectivity module 450 performs a pixel by pixel connectivity analysis to determine whether two or more pixels are coupled/connected to each other within a threshold distance. For example, the threshold may be null or “0” in which the pixels need to be exactly adjacent to each other in order for line connectivity to be positively determined. However, pixels may be analyzed from an imperfect raster image scan, in which some pixels may not be exactly adjacent but may still be within a defined threshold considered to be connected or coupled. The pixel by pixel analysis may simply determine whether each pixel is a foreground of background pixel and attempts to establish line connectivity for pixels of like type (for example, foreground to foreground). Pixel analysis may be performed on a raster image or on vectors.

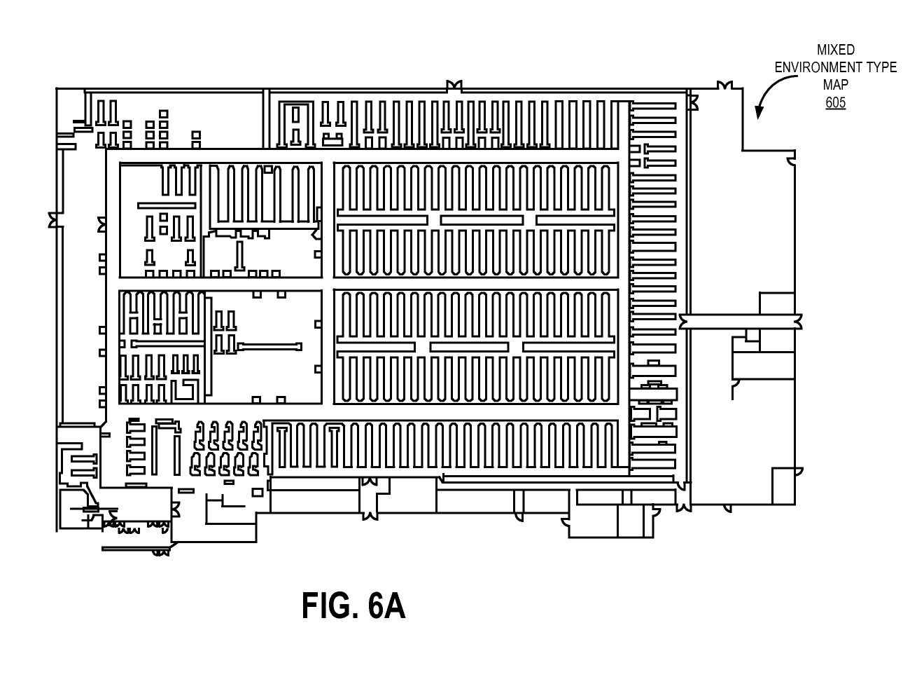

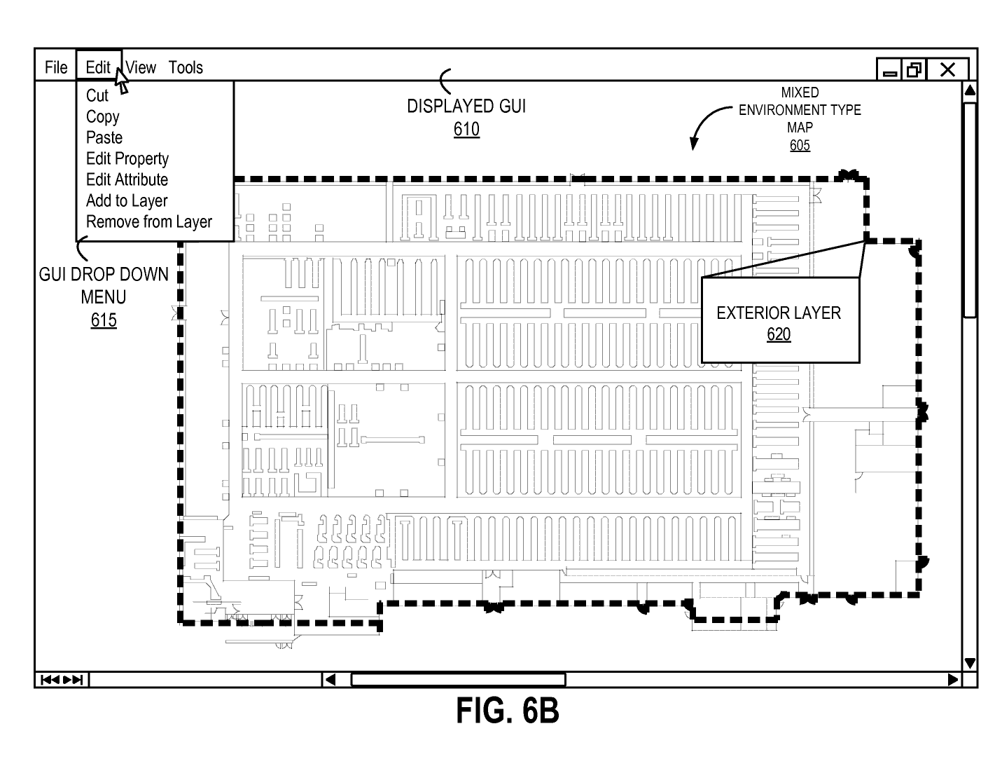

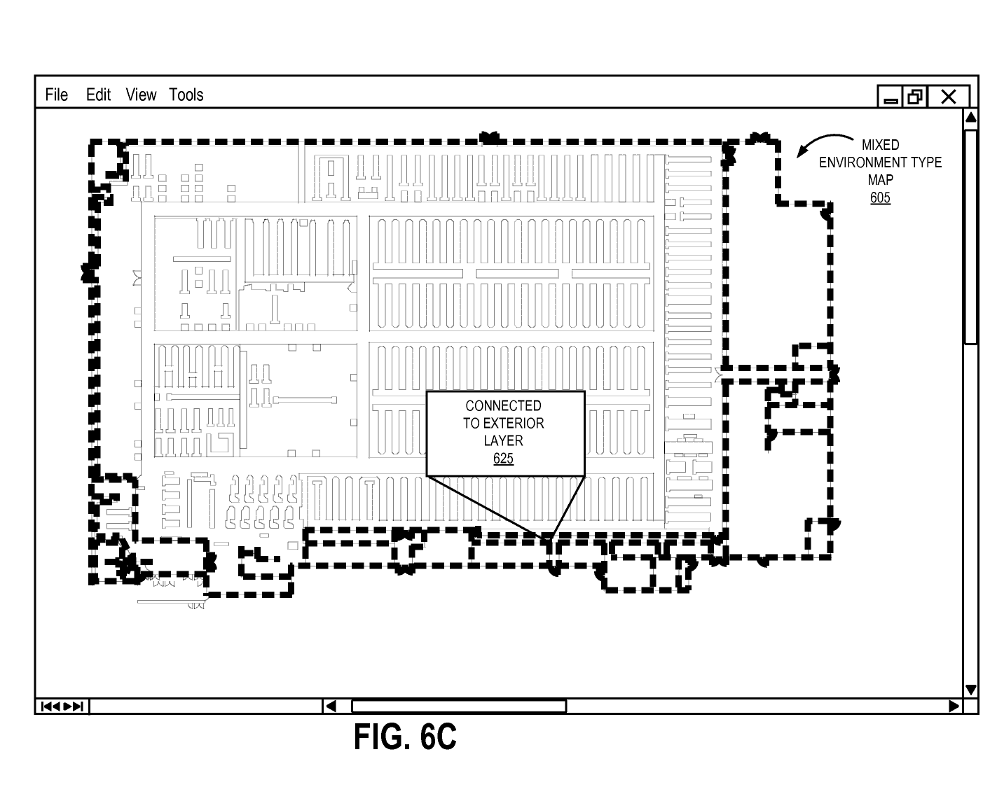

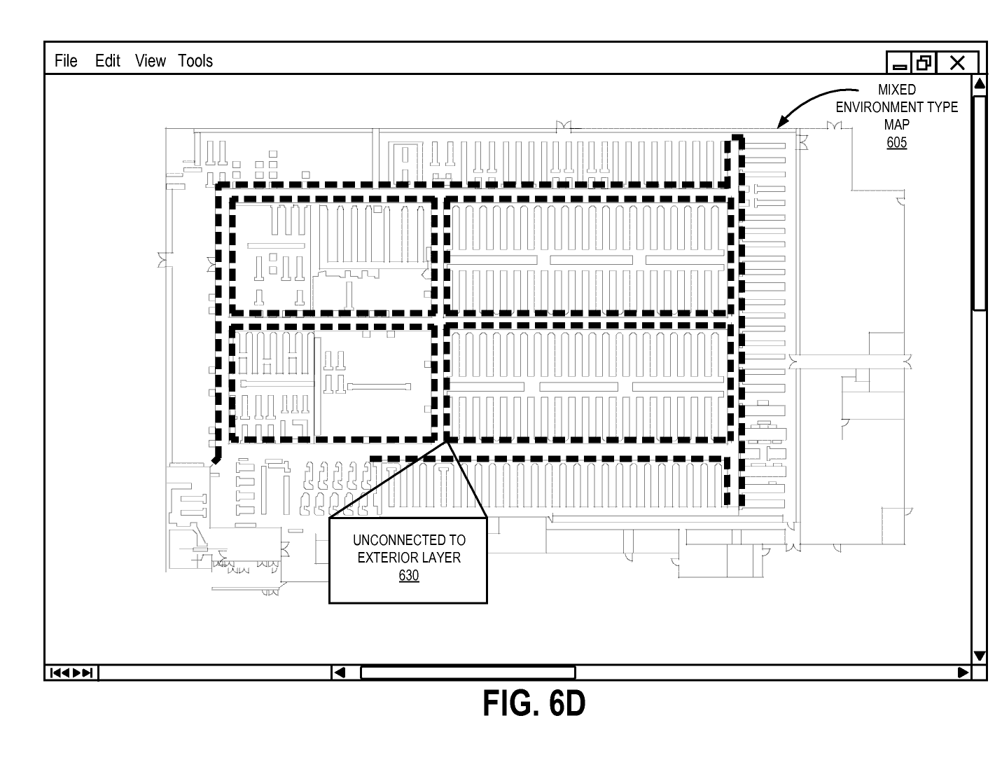

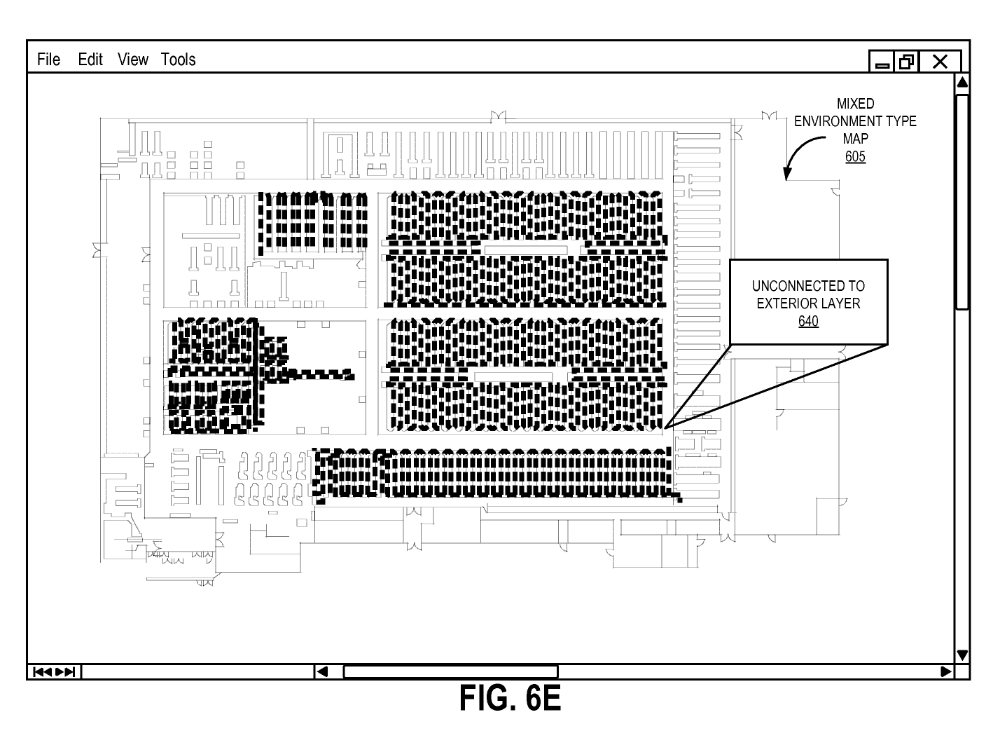

In one embodiment, exterior 455 associates map components with a layer according to positioning of lines or pixels at an outer edge of the input map. In one embodiment, exterior 455 selects exterior lines or elements by tracing an outline of the entire input map and assigning all connected (traced) components to an exterior layer. In some embodiments, a break or gap in connectivity between two exterior components may result in creating a separate exterior layer for the next connected section of exterior component. For example, an exterior wall may be subdivided into multiple layers if exterior 455 detects discontinuity (e.g., a break, or gap of background pixels, etc.) in a set of points around the perimeter of the map. For example, FIG. 6B illustrates exterior layer 620 determined according to exterior sub-module 455, in one embodiment.

In one embodiment, connected to exterior 460 associates map components with a layer according to lines or pixels unconnected to the lines or pixels classified as exterior lines (for example, as provided by exterior 455). For example, as illustrated below in FIG. 6C. In one embodiment, interior lines may be connected or coupled to exterior lines.

In one embodiment, unconnected to exterior 465 associates map components with a layer according to lines or pixels unconnected to the lines or pixels classified as exterior lines (for example, as provided by exterior 455). For example, as illustrated below in FIGS. 6D and 6E. In one embodiment, unconnected to exterior lines may be interior lines connected or coupled to one or more other interior lines.

In one embodiment, line connectivity module 450 may be processed or executed before appearance module 410, or vice versa. Additionally, sub-modules within each respective module may be processed, triggered, or executed in any order or sequence, and the illustration of FIG. 4 is merely one example embodiment. Furthermore, in some embodiments, one or more of the sub-modules may be enabled, disabled, or selectively triggered according to a user request or configuration data 185. For example, a user may instruct MCR to create a layer according to color 415, and then in response to determining the respective layer according to color, MCR may perform connectivity analysis for exterior components according to exterior 455.

In one embodiment, MCR may create a separate layer according to each sub-module of the mixed selector module 405. For example, if a user or setting within configuration data 185 requests a layer for each sub-module, a resulting structured map may include a first layer created by the color 415, a second layer created by the intensity 420, a third layer created by the contrast 425, a fourth layer created by the text 430, a fifth layer created by the exterior 455, a sixth layer created by the connected to exterior 460, and a seventh layer created by the unconnected to exterior 465. In other embodiments, a user requests or configuration data 185 triggers MCR to perform a sub-module on an already determined layer output from a prior sub-module. For example, MCR may create a layer according to the exterior 455, and further process the exterior layer according to appearance module 410 (e.g., color, intensity, contrast, text, etc.). A variety of different layer processing combinations are possible through real-time manual user triggering of each selector within the GUI or as specified within configuration data 185.

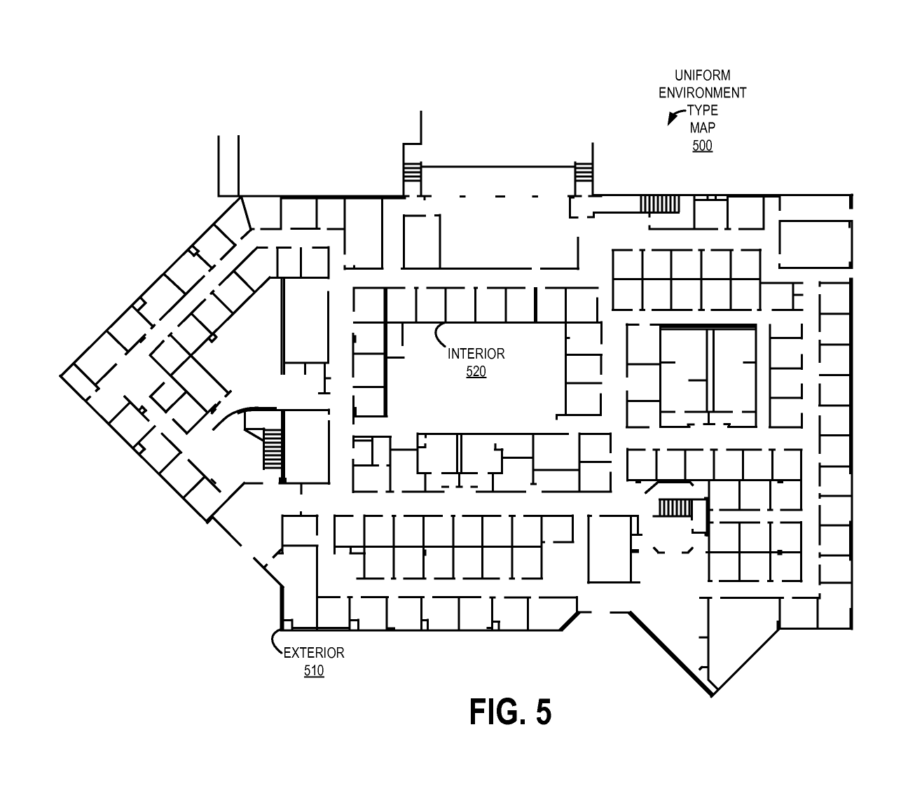

FIG. 5 illustrates a map of a uniform environment type in one embodiment. For example, uniform environment type map 500 may represent a floor layout of a walled office building. One aspect of uniform environment type map 500 is that each element (for example, line, or set of connected pixels), except for stairs, may be considered having the same or similar physical material type metadata. For example, exterior 510 and interior 520 may be assigned one or more similar metadata values.

FIG. 6A illustrates an input map of a mixed environment type in one embodiment. For example, mixed environment type map 605 may represent a commercial store map having a variety of different interior components (e.g., shelves, interior rooms, doors, doorways, counters, partitions, etc.).

FIG. 6B illustrates a graphical user interface selection of an exterior layer in the map of FIG. 6A, in one embodiment. Exterior layer 620 may be structured map layer representing the exterior facing walls of the environment (for example, as determined or output by mixed selector module 405, and/or exterior 455). In one embodiment, displayed GUI 610 has graphical elements and visual representations to enable changes or additions to map 605.

In one embodiment, MCR presents visual representations within displayed GUI 610 on a device display such as display 165. For example, FIG. 6B illustrates presenting, within a GUI (for example, displayed GUI 610), a visual representation of a first group (exterior layer 620) assigned to a first layer. The visual representation is presented such that a user can determine that a group has been selected as part of a layer. GUI drop down menu 615 illustrated in FIG. 6B is another example of a presented visual representation used to provide assistance and feedback to a user while interfacing with displayed GUI 610. Other presented visual representations can include graphics to aid in adding or removing lines or pixels from the selected layer, or adding or removing metadata relating to the layer. For example, a user may use the presented visual representations from displayed GUI 610 to set or assign a material property for exterior layer 620. Displayed GUI 610 can also present a visual representation of an interface for creating a RF heatmap, or classifying a section as blocking or unblocking for pedestrian routing, just to name a few examples.

FIG. 6C illustrates a graphical user interface selection of a connected to exterior layer in the map of FIG. 6A, in one embodiment. For example, FIG. 6C may illustrate presenting, within a GUI (for example, displayed GUI 610), a visual representation of a second group (connected to exterior layer 625) assigned to a second layer. Although not illustrated, the first group of FIG. 6B and the second group of FIG. 6C may be presented together as selectable objects for manipulation within a same displayed GUI 610. Line connectivity module 450 may determine one or more elements are connected or coupled to the exterior layer, and assign the group of components connected or coupled to the exterior layer as an additional layer. In one embodiment, connected to exterior layer 625 may represent a single layer separate from exterior layer 620. In some embodiments, GUI 170 may provide a user with the ability to select and combine (via displayed GUI 610) two separate layers into one layer. For example a single layer may include both connected exterior components and interior components.

FIG. 6D illustrates a graphical user interface selection of an unconnected to exterior layer in the map of FIG. 6A, in one embodiment. Line connectivity module 450 may determine elements not connected to the exterior may also be grouped to form one or more distinct layers. For example, multiple nested interior sections may be detected within a map, each separated into an unconnected to exterior layer. For example, the non-wall components illustrated by unconnected to exterior layer 630 may be components that do not affect RF signal propagation or routability and may be classified (for example, in metadata) as to not influence RF heatmap or routability map results.

FIG. 6E illustrates a graphical user interface selection of an unconnected to exterior layer in the map of FIG. 6A, in another embodiment. For example, the shelf components illustrated by unconnected to exterior layer 640 may be classified (for example, in metadata) to reflect their relative effect on RF signal propagation and routability. If the shelves are determined as not allowing for pedestrian movement, MCR may classify them as blocking in an output routability map. Depending on the metadata assignment for material property, the shelving layer may impact the output heatmap. For example, if the shelves are thinly constructed with a plastic material compared to heavily constructed with steel or wood, the heatmap result may be different.

FIG. 7A illustrates an input map of a mixed environment type, in another embodiment. In some embodiments, FIG. 7A represents an unstructured map (for example a raster map or otherwise unarranged map) as input for processing into a structured map. FIG. 7A illustrates a map of an indoor shopping mall having various sizes and configurations of components (for example, stores, hallways, and other mall sections) and descriptive annotations for points of interest or map areas are illustrated as annotations 769. Additionally, exterior component 710, minor stores 705, major stores 715, and points of interest 745 are illustrated within the map of FIG. 7A. As illustrated in FIG. 7A, various components of the input map are visually separated through the use of contrast, intensity, color, and greyscale shading and other visual elements. In other embodiments, input map components may be illustrated with different colors or with three-dimensional graphics.

FIG. 7B illustrates a contrast selection result based upon processing of the map of FIG. 7A, in one embodiment. In one embodiment, mixed selector module 405 (for example, contrast 425 of the appearance module 410 detection) detects contrast changes within an input map to determine a layer or group having a similar contrast property. For example, as illustrated in FIG. 7B, contrast 425 can detect high contrast pixels (for example, edges) within the input map of FIG. 7A. The resulting layer or group created in response to contrast detection/matching (for example, contrast 425) is illustrated in FIG. 7B as a visual representation presenting just the high contrast (edge) layer 750. In some embodiments, the contrast detection output (for example, contrast layer 750) may be displayed within a GUI (for example, displayed GUI 610) through a series of input commands (for example, by a user). For example, GUI 170 may present or display similar elements as displayed GUI 610 illustrated in FIG. 6B.

FIG. 7C illustrates an intensity selection result based upon processing of the map of FIG. 7A, in one embodiment. As described above, an intensity sub-module (for example, intensity 420) can layer or group components of the input map according to an intensity threshold or range. In one embodiment, an intensity threshold defines the intensity to define a layer or group may be user selectable. For example, adjusting the intensity threshold may determine how similar in intensity each component of a respective layer or group will be. As illustrated in FIG. 7C the intensity threshold is relatively high and results in high intensity threshold layer 755 that includes a subset of the points of interest in the map.

FIG. 7D illustrates an intensity selection result based upon processing of the map of FIG. 7A, in another embodiment. In one embodiment, the intensity threshold from FIG. 7C is adjusted (for example, lowered) to include a wider variety of components with varying intensity. For example, as illustrated in FIG. 7D, all points of interest 745 are included compared to the intensity threshold associated with FIG. 7C. Furthermore, compared to the output of FIG. 7C, the intensity threshold results in low intensity threshold layer 760 that can encompass all intensity values represented in every point of interest and major stores 715.

FIG. 7E illustrates the map of FIG. 7A with the annotation component layer(s) removed, in one embodiment. In one embodiment, annotations 769 including text and icons are selected as a layer and removed or hidden from the input map. For example, the text and icons of FIG. 7A may be included in annotations 769 and defined as one or more annotation layers. If annotations 769 are removed, a white background or other element may be substituted for the annotations (for example, as illustrated by replaced annotations layers). Replaced annotations 770 are illustrated in FIG. 7E as presented, within the GUI, and in response to completing the request to remove annotations 769. FIG. 7A is illustrated as an updated visual representation of the structured map. In some embodiments, certain layers or components may be automatically removed by MCR according to a user request or configuration data 185, or a user may manually select components or layers to remove or hide from a final output structured map. In some embodiments, the annotation layer(s) may be replaced with a background color or pattern. For example, replaced annotations 770 are illustrated as a white background color in FIG. 7E.

FIG. 7F illustrates a contrast selection result based upon processing of the map of FIG. 7E, in one embodiment. In one embodiment, detection and removal of the annotations 770 is performed before contrast 425 in order to create contrast selection layer 775. For example, contrast selection layer 775 isolating the high contrast edges of the input map of FIG. 7A may be the basis for creating a routability map. In some embodiments, the order of execution of mixed selector modules 405 is user selectable or adjusted according to configuration data 185 and the desired final output.

MCR as described herein may be implemented as software, firmware, hardware, module, or engine. In one embodiment, the previous MCR description may be implemented by one or more general purpose processors (for example, processor 110) and in memory 140 to achieve the previously desired functions (for example, the methods of FIGS. 2 and 3).

The teachings herein may be incorporated into (for example, implemented within or performed by) a variety of apparatuses (for example, devices). For example, one or more aspects taught herein may be incorporated into a phone (for example, a cellular phone), a personal data assistant, a tablet, a mobile computer, a laptop computer, a tablet, a user I/O device, a computer, a server, or any other suitable device.

In some aspects a wireless device may comprise an access device (for example, a Wi-Fi access point) for a communication system. Such an access device may provide, for example, connectivity to another network through network interface 105 (for example, a wide area network such as the Internet or a cellular network) via a wired or wireless communication link. Accordingly, the access device may enable another device (for example, a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, executable instructions, commands, information, signals, bits, symbols, and chips that may be referenced throughout the above description may be represented by voltages, currents, electromagnetic waves, magnetic fields or particles, or optical fields or particles, or any combination thereof.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, or discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in random-access memory (RAM), flash memory, read-only memory (ROM), erasable programmable read-only memory (EPROM), electrically erasable programmable read-only memory (EEPROM), registers, hard disk, a removable disk, a compact disk ROM (CD-ROM), or any other form of storage medium known in the art. An exemplary storage medium is coupled to the processor such the processor can read information from, and write information to, the storage medium. In the alternative, the storage medium may be integral to the processor. The processor and the storage medium may reside in an application-specific integrated circuit (ASIC). The ASIC may reside in a user terminal. In the alternative, the processor and the storage medium may reside as discrete components in a user terminal.

In one or more exemplary embodiments, the functions or modules described may be implemented in hardware, software, or firmware, or any combination thereof. If implemented in software as a computer program product, the functions or modules may be stored on or transmitted over as one or more executable instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of executable instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for classifying a map, the method comprising:
receiving an unstructured map of an environment;
detecting a first group of components within the unstructured map sharing a first property;
detecting a second group of components within the unstructured map sharing a second property; and
generating a structured map by assigning the first group of components detected within the unstructured map to a first layer and assigning the second group of components detected within the unstructured map to a second layer.

2. The method of claim 1, wherein the unstructured map further comprises:
a representation, without assigned groups or layers, of a topographical layout of the environment, and
at least one of a vector or a raster component, or both.

3. The method of claim 1, wherein a property comprises at least one of: color, intensity, relative contrast, or line connectivity, or any combination thereof.

4. The method of claim 3, wherein line connectivity comprises at least one of: an exterior wall component coupled to an other exterior wall component, an interior component coupled to an other interior component, an interior component coupled to an exterior wall, or an interior component uncoupled from an exterior wall, or any combination thereof.

5. The method of claim 1, wherein the structured map comprises a vector map, and wherein each group is user selectable.

6. The method of claim 1, further comprising:
receiving at least one of: a first physical material type assignment for the first group of components, or a second physical material type assignment for the second group of components; and
generating a radio frequency propagation heatmap according to the structured map comprising the first group of components having the first physical material type and the second group of components having the second physical material type.

7. The method of claim 1, further comprising:
generating a routability map according to the structured map.

8. The method of claim 1, further comprising:
presenting, within a graphical user interface (GUI), a visual representation of the first group assigned to the first layer and the second group assigned to the second layer, wherein each group is presented as a selectable object for manipulation within the GUI.

9. The method of claim 8, further comprising:
receiving, within the GUI, a selection of the first group;
receiving, within the GUI, a request to update the first group's shared property; and
presenting, within the GUI, a visual representation of the first group having the updated shared property.

10. The method of claim 8, further comprising:
receiving, within the GUI, a selection of the first group;
receiving, within the GUI, a request for at least one of:
removing the first or second group,
assigning components of the structured map to the first or second group, or
removing components of the first or second group,
or any combination thereof; and
presenting, within the GUI and in response to completing the request, an updated visual representation the structured map.

11. The method of claim 8, further comprising:
receiving, within the GUI, at least one of: a first physical material type assignment for the first group of components, or a second physical material type assignment for the second group of components; and
receiving, within the GUI, a request to generate a radio frequency propagation heatmap; and
generating a radio frequency propagation heatmap based at least in part on the at least one of:
the first group of components having the first physical material type, or
the second group of components having the second physical material type.

12. The method of claim 8, further comprising:
receiving, within the GUI, a request to generate a routability map according to the structured map; and
generating the routability map.

13. A machine readable non-transitory storage medium containing executable program instructions which cause a data processing device to perform a method for classifying a map, the method comprising:
receiving an unstructured map of an environment;
detecting a first group of components within the unstructured map sharing a first property;
detecting a second group of components within the unstructured map sharing a second property; and
generating a structured map by assigning the first group of components detected within the unstructured map to a first layer and assigning the second group of components detected within the unstructured map to a second layer.

14. The medium of claim 13, wherein the unstructured map further comprises:
a representation, without assigned groups or layers, of a topographical layout of the environment, and
at least one of a vector or a raster component, or both.

15. The medium of claim 13, wherein a property comprises at least one of: color, intensity, relative contrast, or line connectivity, or any combination thereof.

16. The medium of claim 15, wherein line connectivity comprises at least one of: an exterior wall component coupled to an other exterior wall component, an interior component coupled to an other interior component, an interior component coupled to an exterior wall, or an interior component uncoupled from an exterior wall, or any combination thereof.

17. The medium of claim 13, wherein the structured map comprises a vector map, and wherein each group is user selectable.

18. The medium of claim 13, further comprising instructions for:
receiving at least one of: a first physical material type assignment for the first group of components, or a second physical material type assignment for the second group of components; and
generating a radio frequency propagation heatmap according to the structured map comprising the first group of components having the first physical material type and the second group of components having the second physical material type.

19. The medium of claim 13, further comprising instructions for:
generating a routability map according to the structured map.

20. The medium of claim 13, further comprising instructions for:
presenting, within a graphical user interface (GUI), a visual representation of the first group assigned to the first layer and the second group assigned to the second layer, wherein each group is presented as a selectable object for manipulation within the GUI.

21. The medium of claim 20, further comprising instructions for:
receiving, within the GUI, a selection of the first group;
receiving, within the GUI, a request to update the first group's shared property; and
presenting, within the GUI, a visual representation of the first group having the updated shared property.

22. The medium of claim 20, further comprising instructions for:
receiving, within the GUI, a selection of the first group;
receiving, within the GUI, a request for at least one of:
removing the first or second group,
assigning components of the structured map to the first or second group, or
removing components of the first or second group,
or any combination thereof; and
presenting, within the GUI and in response to completing the request, an updated visual representation of the structured map.

23. The medium of claim 20, further comprising instructions for:
receiving, within the GUI, at least one of: a first physical material type assignment for the first group of components, or a second physical material type assignment for the second group of components; and
receiving, within the GUI, a request to generate a radio frequency propagation heatmap; and
generating a radio frequency propagation heatmap based at least in part on the at least one of:
the first group of components having the first physical material type, or
the second group of components having the second physical material type.

24. The medium of claim 20, further comprising instructions for:
receiving, within the GUI, a request to generate a routability map according to the structured map; and
generating the routability map.

25. A data processing device comprising:
a processor; and
a storage device coupled to the processor and configurable for storing instructions, which, when executed by the processor cause the processor to:
receive an unstructured map of an environment;
detect a first group of components within the unstructured map sharing a first property;
detect a second group of components within the unstructured map sharing a second property; and
generate a structured map by assigning the first group of components detected within the unstructured map to a first layer and assigning the second group of components detected within the unstructured map to a second layer.

26. The device of claim 25, wherein the unstructured map further comprises:
a representation, without assigned groups or layers, of a topographical layout of the environment, and
at least one of a vector or a raster component, or both.

27. The device of claim 25, wherein a property comprises at least one of: color, intensity, relative contrast, or line connectivity, or any combination thereof.

28. The device of claim 27, wherein line connectivity comprises at least one of: an exterior wall component coupled to an other exterior wall component, an interior component coupled to an other interior component, an interior component coupled to an exterior wall, or an interior component uncoupled from an exterior wall, or any combination thereof.

29. The device of claim 25, wherein the structured map comprises a vector map, and wherein each group is user selectable.

30. The device of claim 25, further comprising instructions to:
receive at least one of: a first physical material type assignment for the first group of components, or a second physical material type assignment for the second group of components; and
generate a radio frequency propagation heatmap according to the structured map comprising the first group of components having the first physical material type and the second group of components having the second physical material type.

31. The device of claim 25, further comprising instructions to:
generate a routability map according to the structured map.

32. The device of claim 25, further comprising instructions to:
present, within a graphical user interface (GUI), a visual representation of the first group assigned to the first layer and the second group assigned to the second layer, wherein each group is presented as a selectable object for manipulation within the GUI.

33. The device of claim 32, further comprising instructions to:
receive, within the GUI, a selection of the first group;
receive, within the GUI, a request to update the first group's shared property; and
present, within the GUI, a visual representation of the first group having the updated shared property.

34. The device of claim 32, further comprising instructions to:
receive, within the GUI, a selection of the first group;
receive, within the GUI, a request for at least one of:
removing the first or second group,
assigning components of the structured map to the first or second group, or
removing components of the first or second group,
or any combination thereof; and
presenting, within the GUI and in response to completing the request, an updated visual representation of the structured map.

35. The device of claim 32, further comprising instructions to:
receive, within the GUI, at least one of: a first physical material type assignment for the first group of components, or a second physical material type assignment for the second group of components; and
receive, within the GUI, a request to generate a radio frequency propagation heatmap; and
generate a radio frequency propagation heatmap based at least in part on the at least one of:
the first group of components having the first physical material type, or
the second group of components having the second physical material type.

36. The device of claim 32, further comprising instructions to:
receive, within the GUI, a request to generate a routability map according to the structured map; and
generate the routability map.

37. An apparatus for classifying a map, the apparatus comprising:
means for receiving an unstructured map of an environment;
means for detecting a first group of components within the unstructured map
sharing a first
property;
means for detecting a second group of components within the unstructured map sharing a second property; and
means for generating a structured map by assigning the first group of components detected within the unstructured map to a first layer and assigning the second group of components detected within the unstructured map to a second layer.

38. The apparatus of claim 37, wherein the unstructured map further comprises:
a representation, without assigned groups or layers, of a topographical layout of the environment, and
at least one of a vector or a raster component, or both.

39. The apparatus of claim 37, wherein a property comprises at least one of: color, intensity, relative contrast, or line connectivity, or any combination thereof.

40. The apparatus of claim 39, wherein line connectivity comprises at least one of: an exterior wall component coupled to an other exterior wall component, an interior component coupled to an other interior component, an interior component coupled to an exterior wall, or an interior component uncoupled from an exterior wall, or any combination thereof.

41. The apparatus of claim 37, wherein the structured map comprises a vector map, and wherein each group is user selectable.

42. The apparatus of claim 37, further comprising:
means for receiving at least one of: a first physical material type assignment for the first group of components, or a second physical material type assignment for the second group of components; and
means for generating a radio frequency propagation heatmap according to the structured map comprising the first group of components having the first physical material type and the second group of components having the second physical material type.

43. The apparatus of claim 37, further comprising:
means for generating a routability map according to the structured map.

44. The apparatus of claim 37, further comprising:
means for presenting, within a graphical user interface (GUI), a visual representation of the first group assigned to the first layer and the second group assigned to the second layer, wherein each group is presented as a selectable object for manipulation within the GUI.

45. The apparatus of claim 44, further comprising:
means for receiving, within the GUI, a selection of the first group;
means for receiving, within the GUI, a request to update the first group's shared property; and
means for presenting, within the GUI, a visual representation of the first group having the updated shared property.

46. The apparatus of claim 44, further comprising:
means for receiving, within the GUI, a selection of the first group;
means for receiving, within the GUI, a request for at least one of:
removing the first or second group,
assigning components of the structured map to the first or second group, or
removing components of the first or second group,
or any combination thereof; and
means for presenting, within the GUI and in response to completing the request,
an updated visual representation of the structured map.

47. The apparatus of claim 44, further comprising:
means for receiving, within the GUI, at least one of: a first physical material type assignment for the first group of components, or a second physical material type assignment for the second group of components; and
means for receiving, within the GUI, a request to generate a radio frequency propagation heatmap; and
means for generating a radio frequency propagation heatmap based at least in part on the at least one of:
the first group of components having the first physical material type, or
the second group of components having the second physical material type.

48. The apparatus of claim 44, further comprising:
means for receiving, within the GUI, a request to generate a routability map according to the structured map; and
means for generating the routability map.
